(19) United States
(12) Patent Application Publication
(10) Pub. No.: US 2017/0154174 A1
(43) Pub. Date: Jun. 1, 2017

(54) METHOD FOR UNLOCKING AND ELECTRONIC DEVICE

(71) Applicants: Le Holdings (Beijing) Co., Ltd., Beijing (CN); Le Shi Internet Information Technology Corp. Beijing, Beijing (CN)

(72) Inventor: Yu Zhao, Beijing (CN)

(21) Appl. No.: 15/244,016

(22) Filed: Aug. 23, 2016

Related U.S. Application Data
(63) Continuation of application No. PCT/CN2016/082641, filed on May 19, 2016.

(30) Foreign Application Priority Data
Nov. 27, 2015 (CN) 201510848206.4

(51) Int. Cl. G06F 21/31; G06F 21/62; G06F 3/0488

(52) U.S. Cl. CPC G06F 21/31; G06F 3/04883; G06F 21/6218

(57) ABSTRACT

The present disclosure discloses a method and a device for unlocking. The method includes: collecting a touching behavior acted to an electronic device by a user and obtaining a touching feature of the touching behavior; generating an unlocking password according to the touching feature; matching the unlocking password to a predetermined password; and unlocking a locked state when the unlocking password is matched to the predetermined password correctly.

### CROSS REFERENCE TO RELATED APPLICATIONS

This application is a continuation of International Application No. PCT/CN2016/082641, filed May 19, 2016, which is based upon and claims priority to Chinese Patent Application No. 201510848206.4, filed Nov. 27, 2015, the entire contents of all of which are incorporated herein by reference.

### TECHNICAL FIELD

The present disclosure relates to the field of electronic technology, specifically to a method for unlocking and electronic device.

### BACKGROUND

As the features of an electronic device become more and more powerful, people store much important information, such as photos or private bank information, in an electronic device. Thus, the safety of an electronic device has become more critical.

Currently, screen lock or application program lock of an electronic device is commonly used. A user may lock that of an electronic device first and unlock that when using the electronic device later so as to achieve the corresponding electronic device protection. Therefore, providing a more efficient way of locking and unlocking, in order to improve electronic device security, has become the next major technical problem to solve.

### SUMMARY

The embodiments of the present disclosure provide a method and a device for unlocking, which are used to solve the technical problem that the level of security of an electronic device is lower in the prior arts.

The embodiments of the present disclosure provide a method for unlocking including:

collecting a touching behavior acted to the electronic device by the user and obtaining touching features corresponding to the touching behavior;

generating an unlocking password according to the touching features and matching the unlocking password to a predetermined password; and

unlocking a locked state when the unlocking password is matched to the predetermined password correctly.

The embodiments of the present disclosure provide an electronic device, including:

at least one processor; and

a memory communicably connected with the at least one processor for storing instructions executable by the at least one processor,

wherein execution of the instructions by the at least one processor causes the at least one processor to:

collect a touching behavior acted to an electronic device by a user and obtain touching features of the touching behavior;

generate an unlocking password according to the touching features;

match the unlocking password to a predetermined password; and

unlock a locked state when the unlocking password is matched to the predetermined password correctly.

The embodiments of the present disclosure provide a non-transitory computer-readable storage medium storing executable instructions that, when executed by an electronic device with a touch-sensitive display, cause the electronic device to:

collect a touching behavior acted to an electronic device by a user and obtain touching features of the touching behavior;

generate an unlocking password according to the touching features;

match the unlocking password to a predetermined password; and

unlock a locked state when the unlocking password is matched to the predetermined password correctly.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed .

FIG. 1 is a flowchart of a method for unlocking in accordance with an embodiment of the present disclosure.

FIG. 2 is a flowchart of the method for unlocking in accordance with another embodiment of the present disclosure.

FIG. 3 presents a diagram of the structure of a device for unlocking in accordance with some embodiments of the present disclosure.

FIG. 4 presents a diagram of the structure of the device for unlocking in accordance with some embodiments of the present disclosure.

FIG. 5 presents a diagram of the structure of the device for unlocking in accordance with some embodiments of the present disclosure.

FIG. 6 presents a diagram of the structure of the device for unlocking in accordance with some embodiments of the present disclosure.

FIG. 7 presents a diagram of the structure of an electronic device in accordance with some embodiments of the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and corresponding drawings of the present disclosure. Apparently, the embodiments described are merely partial embodiments of the present disclosure, rather than all embodiments. Other embodiments derive by those having ordinary skills in the art on the basis of the embodiments of the disclosure without going through creative efforts shall all fall within a the protection scope of the present disclosure.

The embodiments of the present disclosure are mainly applied to the unlocking of a screen or an application program of an electronic device. The electronic device may be a mobile phone, a smartphone, a tablet computer/PAD, or a personal digital assistant (PDA), etc.; however, the present disclosure is not limited thereto.

To improve the security of an electronic device, the inventor had done a series of studies and presented the technical solutions of the present disclosure. In the embodiments of the present disclosure, the security of an electronic device is improved through the following steps: collecting a touching behavior acted to an electronic device by a user and obtaining a touching feature of the touching behavior; generating an unlocking password according to the touching feature of the touching behavior; and unlocking a locked state of an electronic device when the unlocking password is matched to a predetermined password correctly.

The touching feature may be different touching durations of touching behavior performed in a position or different positions of the touching behavior performed in two positions. Thus, the unlocking operation movement is within a smaller area and harder to be seen/identified (by others). Therefore, the security of an electronic device may be improved.

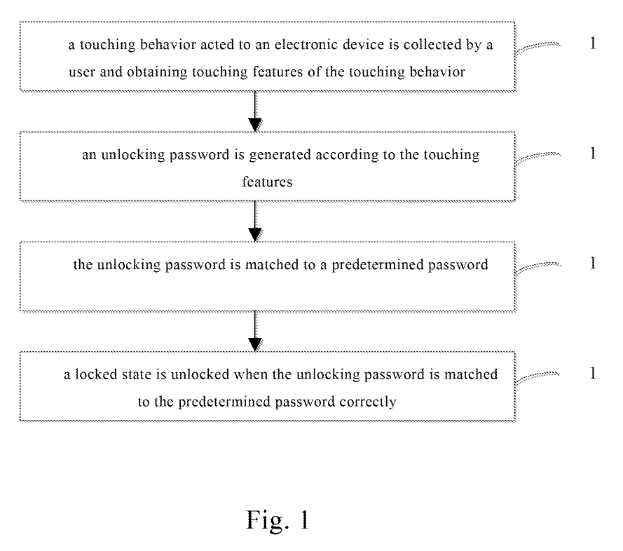

Please refer to FIG. 1, which is a flowchart of a method for unlocking in accordance with an embodiment of the present disclosure. The method includes the following steps.

In Step 101, a touching behavior acted to an electronic device by a user is collected and touching features of the touching behavior is obtained.

“Collecting a touching behavior acted to an electronic device by a user” be performed when a screen or any application program of an electronic device is in a locked state.

In one of the available methods, the touching feature may be touching duration. Thus, the touching behavior may be performed in a position only. The operation movement is within a smaller area.

To be specific, “collecting the touching behavior acted to the electronic device by the user and obtaining a touching feature corresponding to the touching behavior” is as follows:

Collecting the touching behavior performed by the user in any position on a screen of the electronic device and obtaining touching duration corresponding to the touching behavior.

As another available method, the characteristic may be at least one position of the touching behavior. To reduce the area of touching behavior, the at least one position of the touching behavior includes one position of the touching behavior or two positions of the touching behavior. When the at least one position of the touching behavior includes a first position and a second position, to be specific, collecting the touching behavior acted to the electronic device by the user and obtaining at least one position of the touching behavior corresponding to the touching behavior is as follows:

Collecting touching behaviors performed by the user in the first position and the second position respectively on the screen of the electronic device; and obtaining each position of the touching behavior corresponding to each of the operations.

In Step 102, an unlocking password is generated according to the touching features.

In Step 103, the unlocking password is matched to a predetermined password.

In Step 104, a locked state is unlocked when the unlocking password is matched to the predetermined password correctly.

When the unlocking password is matched to the predetermined password correctly, that is, the unlocking password is the same as the predetermined password, the locked state of the screen or the application program of the electronic device is unlocked. Thus the unlocking of the electronic device has been performed.

In this embodiment, the security of the electronic device is improved through the following steps: collecting a touching behavior acted to an electronic device by a user and obtaining a touching feature of the touching behavior; generating an unlocking password according to the touching feature of the touching behavior; and unlocking a locked state when the unlocking password is matched to the predetermined password correctly.

The touching feature may be touching duration or a position of the touching behavior. The touching behavior may be performed in only one position or in two positions. Thus the unlocking operation movement is within a smaller area. Furthermore, the unlocking password includes the touching duration of each touching behavior or each position of each touch so that the unlocking password is harder to be seen/identified (by others). Therefore, the security of the electronic device may be improved.

There may be several available methods for “Generating an unlocking password according to the touching feature corresponding to each touching behavior”. In one of the available methods, the unlocking password may be set as a touching feature corresponding to the touching behavior.

When the touching feature is touching duration, the unlocking password may be set as the touching duration of each touching behavior.

When the touching feature is a position of the touching behavior, the unlocking password may be set as the position of the touching behavior of each touching behavior.

The predetermined password is generated in advance by the following method.

A touching behavior acted to an electronic device is collected by a user in accordance with a touching rule of the predetermined password, wherein the touching rule of the predetermined password includes the touching feature corresponding to each touching behavior.

The touching feature of each of the touching behaviors is set as the predetermined password and saving the predetermined password.

When the touching feature is touching duration, to be specific, the method is collecting a touching behavior acted to the electronic device by a user according to the touching rule of the predetermined password; and setting the touching duration of each of the touching behaviors as the predetermined password and saving the predetermined password, wherein the touching rule of the predetermined password includes touching duration corresponded with each touching behavior.

When the touching feature is a position of the touching behavior, to be specific, the method is collecting the touching behavior acted to the electronic device by the user according to the touching rule of the predetermined password; and setting the position of the touching behavior of each of the touching behaviors as the predetermined password and saving the predetermined password, wherein the touching rule of the predetermined password includes the position of the touching behavior corresponding to each touching behavior.

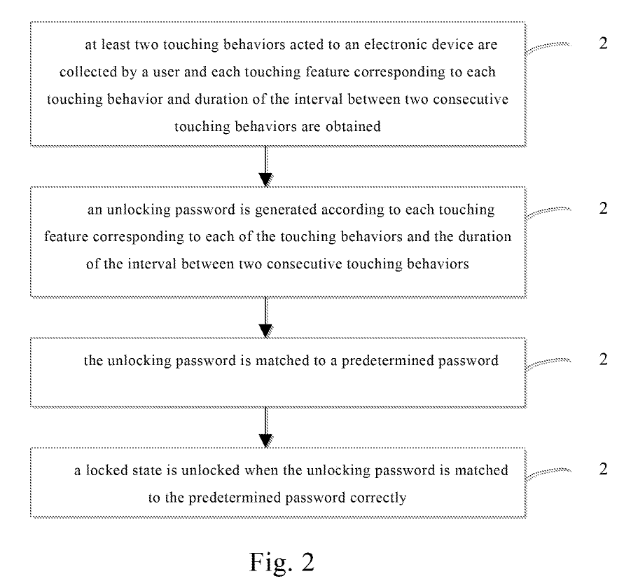

Please refer to FIG. 2, which is a flowchart of the method for unlocking in accordance with another embodiment of the present disclosure. In order to improve the security of the electronic device more significantly, the method may include the following steps.

In Step 201, at least two touching behaviors acted to an electronic device by a user are collected and each touching feature corresponding to each touching behavior and duration of the interval between two consecutive touching behaviors are obtained, wherein the touching feature may be touching duration or a position of the touching behavior.

In Step 202, an unlocking password is generated according to each touching feature corresponding to each of the touching behaviors and the duration of the interval between two consecutive touching behaviors.

In Step 203, the unlocking password is matched to a predetermined password.

In one of the available methods, the predetermined password may be generated in advance according to the touching feature of the at least two touching behaviors and the duration of the interval between two consecutive touching behaviors performed by the user in accordance with a touching rule of the predetermined password. The rule of the predetermined password includes the touching feature of each touching behavior and the touching feature of the two consecutive touching behaviors.

Of course, as another available method, the duration of the interval between two consecutive touching behaviors may be used for determining if the at least two performed touching behaviors are all unlocking operations. For example, the duration of the interval is within a default range, e.g. more than 1 second and less than 2 seconds. When the duration of the interval between two consecutive touching behaviors is less than 1 second or more than 2 seconds, the later touching behavior next to the duration of the interval, which is less than 1 second and more than 2 seconds, may be determined as “not an unlocking operation”. To be specific, “generating an unlocking password according to each touching feature corresponding to each of the touching behaviors and the duration of the interval between two consecutive touching behaviors” is generating an unlocking password according to the touching feature corresponding to at least two touching behaviors, whose duration of the interval between two consecutive touching behaviors is within the default range, and the duration of the interval between two consecutive touching behaviors.

In Step 204, a locked state is unlocked when the unlocking password is matched to the predetermined password correctly.

In this embodiment, an unlocking password is generated according to the touching feature and the duration of the interval between two consecutive touching behaviors. Also, the predetermined password is generated in advance according to the touching feature of the at least two touching behaviors and the duration of the interval between two consecutive touching behaviors performed by the user in accordance with a touching rule of the predetermined password. Thus the degree of complexity of the unlocking password is increased so that the unlocking operation movement is even harder to be seen/identified (by others). Therefore, the security of the electronic device may be improved more significantly.

There may be several available methods for “Generating an unlocking password according to each touching feature corresponding to each of the touching behaviors and the duration of the interval between two consecutive touching behaviors”.

In one of the available methods, “Generating an unlocking password according to each touching feature corresponding to each of the touching behaviors and the duration of the interval between two consecutive touching behaviors” may specifically include the following step.

Each touching feature corresponding to each of the touching behaviors and the duration of the interval between the two consecutive touching behaviors is set as the unlocking password.

Then the predetermined password is generated in advance by the following method.

At least two touching behaviors acted to the electronic device is collected by a user in accordance with a touching rule of the predetermined password, wherein the touching rule of the predetermined password includes each touching feature corresponding to each touching behavior and the duration of the interval between two consecutive touching behaviors.

Each touching feature corresponding to each of the at least two touching behaviors and the duration of the interval between the two consecutive touching behaviors is set as the predetermined password and saving the predetermined password.

For example, the touching feature is touching duration. When setting the predetermined password, the user performs the touching behavior more than 1 time, e.g. 5 times, on the electronic device according to the touching rule of the predetermined password. The touching duration of each of the touching behaviors and duration of the interval between two consecutive touching behaviors are obtained. All of the touching features respectively corresponding to all of the touching behaviors may be the same or different. For example, the touching duration of the first touching behavior is 1 second. The touching duration of the second touching behavior is 2 seconds. The touching duration of the third touching behavior is 1 second. The touching duration of the fourth touching behavior is 2 seconds. The touching duration of the fifth touching behavior is 2 seconds. The duration of each interval between two consecutive touching behaviors is (the same) 2 seconds. Thus the predetermined password is: the touching duration of the first touching behavior, i.e. 1 second; the touching duration of the second touching behavior, i.e. 2 seconds; the touching duration of the third touching behavior, i.e. 1 second, the touching duration of the fourth touching behavior, i.e. 2 seconds; the touching duration of the fifth touching behavior, i.e. 2 seconds; and the duration of each interval between two consecutive touching behaviors, i.e. (the same) 2 seconds. When the user performs an unlocking operation, when the touching duration of each of the 5 touching behaviors and the duration of each interval between two consecutive touching behaviors are the same as the predetermined password, the locked state of the electronic device may be unlocked.

For example, the touching feature is at least one position of the touching behavior. The position of the touching behavior includes two positions: a first position and a second position. The first position and the second position may be set in advance. The user performs the touching behavior more than 1 time, e.g. 5 times, on the electronic device according to the touching rule of the predetermined password. The position of the touching behavior of each of the touching behaviors and duration of the interval between two consecutive touching behaviors are obtained. For example, the position of the touching behavior of the first touching behavior is the first position. The position of the touching behavior of the second touching behavior is the first position. The position of the touching behavior of the third touching behavior is the first position. The position of the touching behavior of the fourth touching behavior is the second position. The position of the touching behavior of the fifth touching behavior is the second position. The duration of each interval between two consecutive touching behaviors is (the same) 2 seconds. Thus, the position of the touching behavior of the first touching behavior is the first position. The position of the touching behavior of the second touching behavior is the first position. The position of the touching behavior of the third touching behavior is the first position. The position of the touching behavior of the fourth touching behavior is the second position. The position of the touching behavior of the fifth touching behavior is the second position. The duration of each interval between two consecutive touching behaviors is (the same) 2 seconds. When the user performs an unlocking operation, when the position of the touching behavior of each of the 5 touching behaviors and the duration of each interval between two consecutive touching behaviors are the same as the predetermined password, the locked state of the electronic device may be unlocked.

In order to improve the security of the electronic device more significantly, as another available method, generating an unlocking password according to each touching feature corresponding to each of the touching behaviors and the duration of the interval between two consecutive touching behaviors may include the following step.

Each touching feature corresponding to each of the touching behaviors is converted to code symbols according to different touching features corresponding to different code symbols, the duration of the interval between the code symbols, and the duration of the interval between characters, which are obtained through a permutation of the code symbols; converting the code symbols to a combination of characters according to the duration of the interval between two consecutive touching behaviors; and the combination of characters is set as the unlocking password.

When the touching feature is touching duration, different touching durations correspond to different code symbols. When the touching feature is a position of the touching behavior, different positions of the touching behavior correspond to different code symbols. A corresponding character may be obtained through a permutation of the code symbols.

A combination of characters may be obtained according to the duration of the interval between the code symbols; and the duration of the interval between characters. The combination of characters may be the unlocking password then.

Then the predetermined password may be a combination of characters set in advance. For example, the predetermined password may be a combination of characters, “tina”.

Also, the predetermined password may be generated in advance by the following method.

At least two touching behaviors acted to the electronic device is collected by the user in accordance with a touching rule of the predetermined password, wherein the touching rule of the predetermined password includes each touching feature corresponding to each touching behavior and the duration of the interval between two consecutive touching behaviors;

Each touching feature corresponding to each of the touching behaviors is converted to code symbols according to different touching features corresponding to different code symbols, the duration of the interval between the code symbols, and the duration of the interval between characters, which are obtained through a permutation of the code symbols; converting the code symbols to a combination of characters according to the duration of the interval between two consecutive touching behaviors; and the combination of characters is set as the unlocking password.

Similarly, when the touching feature is touching duration, different touching duration corresponds to a different code symbol. When the touching feature is a position of the touching behavior, different positions of the touching behavior corresponds to different code symbols. A corresponding character may be obtained through a permutation of the code symbols. A combination of characters may be obtained according to the duration of the interval between the code symbols, and the duration of the interval between characters. The combination of characters may be the predetermined password.

Different touching features corresponding to different code symbols; the duration of the interval between the code symbols; and the duration of the interval between characters, which are obtained through a permutation of the code symbols; may be defined in the touching rule of the predetermined password.

In one practical application, the touching rule of the predetermined password may be the rules of Morse code. Therefore, the setting of the predetermined password may be performed according to the rules of Morse code. The touching behavior is performed according to the rules of Morse code, and the unlocking password is obtained. When the setting of the password and the unlocking operation are according to the rules of Morse code, the password (or the unlocking operation movement) is harder to be seen or identified (by others). Therefore, the security of the electronic device may be greatly improved.

The code symbol includes “.” and “-” in the rules of Morse code. In the embodiments of the present disclosure, there is a possible way: when the touching duration is first duration, the code symbol corresponding to the first duration may be set as “.”; when the touching duration is second duration, the code symbol corresponding to the second duration may be set as “-”.

There is another possible way: when the position of the touching behavior is the first position, the code symbol corresponding to the first position may be set as “.”; when the position of the touching behavior is the second position, the code symbol corresponding to the second position may be set as “-”.

The duration of the interval between code symbols is third duration. The duration of the interval between characters is fourth duration. For example, the first duration may be 1 second. The second duration may be 2 seconds. The third duration may be 1 second. The fourth duration may be 3 seconds.

Please refer to the following table: characters obtained through a permutation of the code symbols

| Char- | Code | Char- | Code | Char- | Code |
|---|---|---|---|---|---|
| acter | Symbol | acter | Symbol | acter | Symbol |
| A | •— | N | —• | 1 | •———— |
| B | —••• | O | ——— | 2 | ••——— |
| C | —•—• | P | •——• | 3 | •••—— |
| D | —•• | Q | ——•— | 4 | ••••— |
| E | • | R | •—• | 5 | ••••• |
| F | ••—• | S | ••• | 6 | —•••• |
| G | ——• | T | — | 7 | ——••• |
| H | •••• | U | ••— | 8 | ———•• |
| I | •• | V | •••— | 9 | ————• |
| G | •——— | W | •—— | 0 | ————— |
| K | —•— | X | —••— | ? | ••——•• |
| L | •—•• | Y | —•—— | / | —••—• |
| M | —— | Z | ——•• | ( ) | —•——•— |
| — | —••••— | • | •—•—•— | | |

Therefore, when the user sets the predetermined password, he/she may perform the touching behavior at least two times according to the rules of Morse code.

For example, the user wants to use “tina” as the predetermined password. According to the above table, the code symbols corresponding to “tina” are “- . . - . . -”. He/she may perform the touching behavior 7 times according to the code symbols. For example, when the touching duration is first duration, the code symbol corresponding to the first duration is “.”; when the touching duration is second duration, the code symbol corresponding to the second duration is “-”.

The touching duration of the first touching behavior is the second duration. The duration of the interval between the first touching behavior and the second touching behavior is the fourth duration. Thus, the character corresponding to the code symbol corresponding to the first touching behavior is “t”.

The touching duration of the second touching behavior is the first duration; the touching duration of the third touching behavior is the first duration, too. The duration of the interval between the second touching behavior and the third touching behavior is the third duration. The duration of the interval between the third touching behavior and the fourth touching behavior is the fourth duration. Thus the combination of the code symbols respectively corresponding to the second touching behavior and the third touching behavior is the character “i”.

The touching duration of the fourth touching behavior is the second duration. The touching duration of the fifth touching behavior is the first duration. The duration of the interval between the fourth touching behavior and the fifth touching behavior is the third duration. The duration of the interval between the fifth touching behavior and the sixth-time touching behavior is the fourth duration. Thus the combination of the code symbols respectively corresponding to the fourth touching behavior and the fifth touching behavior is the character “n”.

The touching duration of the sixth-time touching behavior is the first duration. The touching duration of the seventh-time touching behavior is the second duration. The duration of the interval between the sixth-time touching behavior and the seventh-time touching behavior is the third duration. Thus the combination of the code symbols respectively corresponding to the sixth-time touching behavior and the seventh-time touching behavior is the character “a”.

The electronic device may set each touching feature of each of the at least two touching behaviors and the duration of the interval between the consecutive touching behaviors as the predetermined password. The electronic device may also convert each touching feature of each of at least two touching behaviors and the duration of the interval between the consecutive touching behaviors; according to different touching features corresponding to different code symbols, the duration of the interval between the code symbols, and the duration of the interval between characters, which are obtained through a permutation of the code symbols; to a combination of characters, e.g. “tina”. Then the electronic device may set “tina” as the predetermined password.

When the user performs an unlocking operation on the electronic device, if the predetermined password is known, he/she may perform the touching behavior according to the touching feature and the duration an interval between consecutive touching behaviors corresponding to the predetermined password.

When the predetermined password is each touching feature corresponding to at least two touching behaviors and the duration of the interval between two consecutive touching behaviors, according to the rules of Morse code, performed by a user, the electronic device may match the obtained each touching feature corresponding to at least two touching behaviors and the duration of the interval between two consecutive touching behaviors to the predetermined password correctly, so that the locked state of the electronic device is unlocked.

When the predetermined password is a combination of characters, (when the user performs an unlocking operation,) the electronic device may convert the touching feature of the touching behavior and the duration of the interval between consecutive touching behaviors to a combination of characters. When the combination of characters is matched to the predetermined password correctly, the locked state of the electronic device is unlocked.

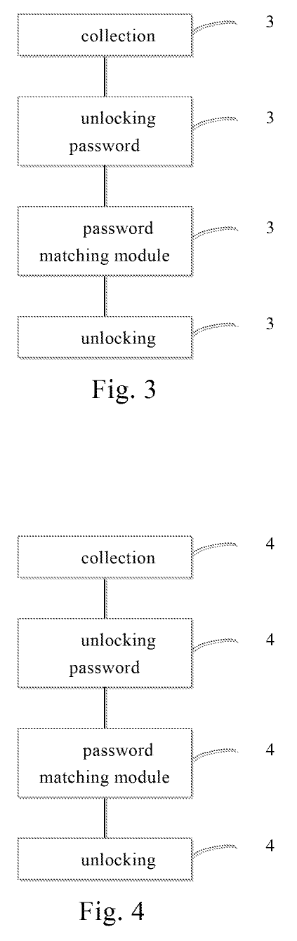

FIG. 3 presents a diagram of the structure of a device for unlocking in accordance with some embodiments of the present disclosure. The device includes: a collection module 301, an unlocking password generation module 302, a password matching module 303, and an unlocking module 304.

The collection module 301 is used for collecting a touching behavior acted to an electronic device by a user and obtaining a touching feature of the touching behavior.

The touching feature may be touching duration or a position of the touching behavior.

When the touching feature is touching duration, the collection module is specifically used for collecting the touching behavior performed by the user in any position on a screen of the electronic device and obtaining touching duration corresponding to the touching behavior.

When the touching feature is the position of the touching behavior, the collection module is specifically used for: collecting touching behaviors performed by the user in the first position and the second position respectively on the screen of the electronic device; and obtaining each position of the touching behavior corresponding to each of the operations.

The unlocking password generation module 302 is used for generating an unlocking password according to the touching feature.

The password matching module 303 is used for matching the unlocking password to a predetermined password.

The unlocking module 304 is used for unlocking a locked state of the electronic device when the unlocking password is matched to the predetermined password correctly.

The touching behavior acted to the electronic device by a user may be performed by touching the screen of the electronic device.

In this embodiment, by collecting a touching behavior acted to an electronic device by a user and obtaining a touching feature of each touching behavior; generating an unlocking password according to the touching feature of each touching behavior; and unlocking a locked state of the electronic device when the unlocking password is matched to the predetermined password correctly, the electronic device security is improved.

The touching feature may be touching duration or a position of the touching behavior. The touching behavior may be performed in only one position or in two positions. Thus the unlocking operation movement is within a smaller area. Furthermore, the unlocking password consists of touching duration of each touching behavior or each position of the touching behavior of each touching behavior so that the unlocking password is harder to be seen/identified (by others). Therefore, the security of the electronic device may be improved.

The unlocking password generation module is used for “generating an unlocking password according to the touching feature corresponding to each touching behavior”, which may have several available methods. In one of the available methods, the unlocking password generation module may set the touching feature corresponding to the touching behavior as the unlocking password.

When the touching feature is touching duration, the unlocking password generation module is specifically used for setting the touching duration of each touching behavior as the unlocking password.

When the touching feature is a position of the touching behavior, the unlocking password generation module is specifically used for setting the position of the touching behavior of each touching behavior as the unlocking password.

The device may further include a first password setting module. The first password setting module is used for used for collecting a touching behavior acted to the electronic device by a user in accordance with a touching rule of the predetermined password; and setting the touching feature of each of the touching behaviors as the predetermined password and saving the predetermined password. The touching rule of the predetermined password includes the touching feature of each of the touching behaviors.

When the touching feature is touching duration, the first password setting module is specifically used for collecting a touching behavior acted to the electronic device by a user in accordance with a touching rule of the predetermined password; and setting the touching duration corresponding to the touching behavior as the predetermined password and saving the predetermined password. The touching rule of the predetermined password includes touching duration corresponded with each touching behavior.

When the touching feature is a position of the touching behavior, the first password setting module is specifically used for collecting the touching behavior acted to the electronic device by the user according to the touching rule of the predetermined password; and setting the position of the touching behavior corresponding to each of the touching behaviors as the predetermined password and saving the predetermined password, wherein the touching rule of the predetermined password includes the position of the touching behavior corresponding to each touching behavior.

In order to improve the security of the electronic device more significantly, the duration of the interval between two consecutive touching behaviors may be used for the unlocking password also when the user performs an unlocking operation.

FIG. 4 presents a diagram of the structure of the device for unlocking in accordance with some embodiments of the present disclosure. The device may include: a collection module 401, an unlocking password generation module 402, a password matching module 403, and an unlocking module 404.

The collection module 401 is used for collecting at least two touching behaviors acted to the electronic device by the user and obtaining each touching feature corresponding to each touching behavior and duration of the interval between two consecutive touching behaviors.

The unlocking password generation module 402 is used for generating an unlocking password according to each touching feature corresponding to each of the touching behaviors and the duration of the interval between two consecutive touching behaviors.

The password matching module 403 is used for matching the unlocking password to a predetermined password.

The predetermined password may be generated in advance according to the touching feature of at least two touching behaviors performed by the user and the duration of the interval between two consecutive touching behaviors in accordance with a touching rule of the predetermined password. The rule of the predetermined password includes the touching feature of each touching behavior and the touching feature of the two consecutive touching behaviors.

The unlocking module 404 is used for unlocking a locked state when the unlocking password is matched to the predetermined password correctly.

In this embodiment, an unlocking password is generated according to the touching feature and the duration of the interval between two consecutive touching behaviors. Also, the predetermined password is generated in advance according to the touching feature of the at least two touching behaviors performed by the user and the duration of the interval between two consecutive touching behaviors according to the touching rule of the predetermined password. Thus the degree of complexity of the unlocking password is increased so that the unlocking operation movement is harder to be seen/identified (by others). Therefore, the security of the electronic device may be improved more significantly.

There may be several available methods for “Generating an unlocking password according to each touching feature corresponding to each of the touching behaviors and the duration of the interval between two consecutive touching behaviors”.

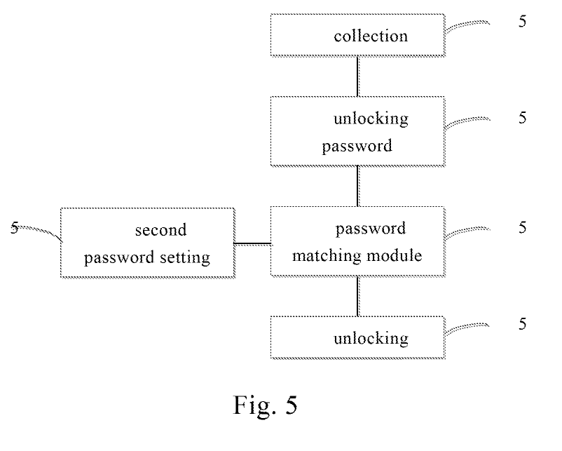

FIG. 5 presents a diagram of the structure of the device for unlocking in accordance with some embodiments of the present disclosure. The device may include: a collection module 501, an unlocking password generation module 502, a password matching module 503, an unlocking module 504.

The collection module 501 is used for collecting at least two touching behaviors acted to the electronic device by a user and obtaining each touching feature corresponding to each touching behavior and duration of the interval between two consecutive touching behaviors.

The unlocking password generation module 502 is used for generating an unlocking password according to each touching feature corresponding to each of the touching behaviors and the duration of the interval between two consecutive touching behaviors.

The password matching module 503 is used for matching the unlocking password to a predetermined password.

The unlocking module 504 is used for unlocking a locked state when the unlocking password is matched to the predetermined password correctly.

In this embodiment, the unlocking password is generated according to the touching feature corresponding to each of the touching behaviors and the duration of the interval between two consecutive touching behaviors according to the execution order of at least two touching behaviors. Thus the degree of complexity of the unlocking password is increased so that the unlocking operation movement is harder to be seen/identified (by others). Therefore, the security of the electronic device may be improved more significantly.

As shown in FIG. 5, the device may further include a second password setting module 505.

The second password setting module 505 is used for collecting at least two touching behaviors acted to the electronic device by a user in accordance with a touching rule of the predetermined password; and setting each touching feature corresponding to each touching behavior and the duration of the interval between the two consecutive touching behaviors as the predetermined password and saving the predetermined password, wherein the touching rule of the predetermined password includes the touching feature corresponding to each touching behavior and the duration of the interval between the two consecutive touching behaviors.

Another available method for generating an unlocking password is described in the following paragraphs:

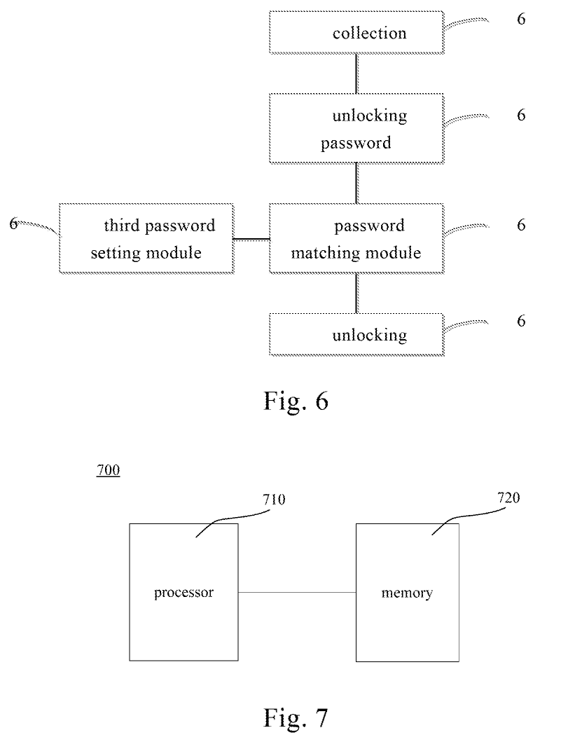

FIG. 6 presents a diagram of the structure of the device for unlocking in accordance with some embodiments of the present disclosure. The device may include: a collection module 601, an unlocking password generation module 602, a password matching module 603, an unlocking module 604, a third password setting module 605.

The collection module 601 is used for collecting at least two touching behaviors acted to an electronic device by a user and obtaining each touching feature corresponding to each touching behavior and duration of the interval between two consecutive touching behaviors.

The unlocking password generation module 602 may be specifically used for converting each touching feature corresponding to each of the touching behaviors to code symbols according to touching features corresponding to different code symbols, the duration of the interval between the code symbols, and the duration of the interval between characters, which are obtained through a permutation of the code symbols; converting the code symbols to a combination of characters according to the duration of the interval between two consecutive touching behaviors; and setting the combination of characters as the unlocking password.

The password matching module 603 is used for matching the unlocking password to a predetermined password.

The unlocking module 604 is used for unlocking a locked state when the unlocking password is matched to the predetermined password correctly.

The third password setting module 605 is specifically used for collecting at least two touching behaviors acted to the electronic device by a user in accordance with a touching rule of the predetermined password, wherein the touching rule of the predetermined password includes each touching feature corresponding to each touching behavior and the duration of the interval between two consecutive touching behaviors; converting each touching feature corresponding to each of the touching behaviors to code symbols according to touching features corresponding to different code symbols, the duration of the interval between the code symbols, and the duration of the interval between characters, which are obtained through a permutation of the code symbols; converting the code symbols to a combination of characters according to the duration of the interval between two consecutive touching behaviors; setting the combination of characters as the predetermined password; and saving the predetermined password.

In this embodiment, the unlocking password is generated by the following method: converting each touching feature corresponding to each of the touching behaviors to code symbols according to touching features corresponding to different code symbols, the duration of the interval between the code symbols, and the duration of the interval between characters, which are obtained through a permutation of the code symbols; converting the code symbols to a combination of characters according to the duration of the interval between two consecutive touching behaviors; setting the combination of characters as the unlocking password. Thus the degree of complexity of the unlocking password is increased so that the unlocking operation movement is harder to be seen/identified (by others). Therefore, the security of the electronic device may be improved more significantly.

When the touching feature is touching duration, different touching duration corresponds to a different code symbol. When the touching feature is a position of the touching behavior, different positions of the touching behavior correspond to different code symbols. A corresponding character may be obtained through a permutation of the code symbols.

A combination of characters may be obtained according to the duration of the interval between the code symbols and the duration of the interval between characters. The combination of characters may be the unlocking password then.

Different touching features corresponding to different code symbols; the duration of the interval between the code symbols; and the duration of the interval between characters, which are obtained through a permutation of the code symbols; may be defined in the touching rule of the predetermined password.

The electronic device may set each touching feature of each of the at least two touching behaviors and the duration of the interval between the consecutive touching behaviors as the predetermined password. The electronic device may also convert each touching feature of each of at least two touching behaviors and the duration of the interval between the consecutive touching behaviors; according to different touching features corresponding to different code symbols, the duration of the interval between the code symbols, and the duration of the interval between characters, which are obtained through a permutation of the code symbols; to a combination of characters, e.g. “tina”. Then the electronic device may set “tina” as the predetermined password.

When the user performs an unlocking operation on the electronic device, if the predetermined password is known, he/she may perform the touching behavior according to the touching feature and the duration an interval between consecutive touching behaviors corresponding to the predetermined password.

When the predetermined password is a combination of characters, (when the user performs an unlocking operation,) the electronic device may convert the touching feature of the touching behavior and the duration of the interval between consecutive touching behaviors to a combination of characters. When the combination of characters is matched to the predetermined password correctly, the locked state of the electronic device is unlocked.

FIG. 7 presents a diagram of the structure of an electronic device in accordance with some embodiments of the present disclosure. The electronic device 700 includes:

at least one processor 710; and

a memory 720 communicably connected with the at least one processor 710 for storing instructions executable by the at least one processor 710,

wherein execution of the instructions by the at least one processor 710 causes the at least one processor 710 to:

collect a touching behavior acted to an electronic device by a user and obtain touching features of the touching behavior;

generate an unlocking password according to the touching features;

match the unlocking password to a predetermined password; and

unlock a locked state when the unlocking password is matched to the predetermined password correctly.

In exemplary embodiments, there is also provided non-transitory computer-readable storage medium storing executable instructions, such as included in the memory 720, executable by the at least one processor 710 in the electronic device 700, for performing any of the above-described method for unlocking.

In exemplary embodiments, the electronic device 600 may be various handheld terminals, such as a mobile phone, a personal digital assistant (PDA), etc.

In exemplary embodiments, the non-transitory computer-readable storage medium may be a read-only memory (ROM), a programmable ROM (PROM), an electrically programmable ROM (EPROM), an electrically erasable programmable ROM (EEPROM), a flash memory, a random access memory (RAM) which may act as an external cache memory. As an example and not restrictive, RANI may be obtained in various forms, such as a synchronous RAM (DRAM), a dynamic RAM (DRAM), a synchronous DRAM (SDRAM), a double data rate SDRAM (DDR SDRAM), an enhanced SDRAM (ESDRAM), a synchronization link DRAM (SLDRAM), and a direct RambusRANI (DRRAM). The computer-readable storage medium in the present disclosure are intended to include, but not limited to, these and any other suitable types of memory. The computer-readable storage medium may also be a compression disk (CD), a laser disc, an optical disk, a digital versatile disc (DVD), a floppy disks, a blue-ray disk, etc.

The various illustrative logical blocks, modules and circuits described in combination with the contents disclosed herein may be realized or executed by the following components which are designed for performing the above methods: a general purpose processor, a digital signal processor (DSP), an application specific integrated circuit (ASIC), a field programmable gate array (FPGA), or other programmable logic devices, a discrete gate, or a transistor logic, a discrete hardware element or any combination thereof. The general purpose processor may be a microprocessor. Alternatively, the processor may be any conventional processor, controller, microcontroller or state machine. The processor may also be implemented as a combination of the computing devices, such as a combination of a DSP and a microprocessor, a plurality of microprocessors, one or more microprocessor combined with a DSP core, or any other such configurations.

The embodiments of the methods and device described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present disclosure, but are not intended to limit the protection scope of the present disclosure. Although the present disclosure has been illustrated in detail according to the foregoing embodiments, those having ordinary skills in the art should understand that modifications may still be made to the technical solutions recited in various embodiments described above, or equivalent substitutions may still be made to a part of technical features thereof, and these modifications or substitutions will not make the essence of the corresponding technical solutions depart from the spirit and scope of the claims.

What is claimed is:

1. A method for unlocking, comprising:
collecting a touching behavior acted to an electronic device by a user and obtaining touching features of the touching behavior;
generating an unlocking password according to the touching features and matching the unlocking password to a predetermined password; and
unlocking a locked state when the unlocking password is matched to the predetermined password correctly.

2. The method as claimed in claim 1, wherein the touching feature is touching duration, the generating an unlocking password according to the touching features comprises:
setting the touching duration of the touching behavior as the unlocking password;
wherein the predetermined password is generated in advance by the following methods specifically:
collecting the touching behavior acted to an electronic device by the user in accordance with a touching rule of the predetermined password; and
setting the touching duration of the touching behavior as the predetermined password and saving the predetermined password, the touching rule of the predetermined password comprises the touching duration corresponded with each touch operation.

3. The unlocking method as claimed in claim 1, wherein the touching feature is touching duration or a position of the touching behavior, and the collecting the touching behavior acted to the electronic device by the user and obtaining the touching features of the touching behavior comprise:
collecting at least two touching behaviors acted to the electronic device by the user and obtaining the touching features of each touching behavior and duration of the interval between two consecutive touching behaviors;
the generating an unlocking password according to the touching features comprises:
generating an unlocking password according to each touching feature corresponding to each of the touching behaviors and the duration of the interval between two consecutive touching behaviors.

4. The method as claimed in claim 3, wherein the generating an unlocking password according to each touching feature corresponding to each of the touch behaviors and the duration of the interval between two consecutive touching behaviors comprises:
setting each touching feature corresponding to each of the touching behaviors and the duration of the interval between the two consecutive touching behaviors as the unlocking password;
wherein the predetermined password is generated in advance by the following method specifically:
collecting at least two touching behaviors acted to the electronic device by the user in accordance with a touching rule of the predetermined password, wherein the touching rule of the predetermined password comprises each touching feature corresponding to each touch behavior and the duration of the interval between two consecutive touch behaviors; and
setting each touching feature corresponding to each of the at least two touching behaviors and the duration of the interval between the two consecutive touching behaviors as the predetermined password and saving the predetermined password.

5. The method as claimed in claim 3, wherein the generating an unlocking password according to each touching feature corresponding to each of the touching behaviors and the duration of the interval between two consecutive touching behaviors comprises:
converting each touching feature corresponding to each of the touch behaviors to code symbols according to different touching features corresponding to different code symbols, the duration of the interval between the code symbols, and the duration of the interval between characters which are obtained through a permutation of the code symbols;
converting the code symbols to a combination of characters according to the duration of the interval between two consecutive touching behaviors; and
setting the combination of characters as the unlocking password.

6. An electronic device, comprising:
at least one processor; and
a memory communicably connected with the at least one processor for storing instructions executable by the at least one processor,
wherein execution of the instructions by the at least one processor causes the at least one processor to:
collect a touching behavior acted to an electronic device by a user and obtain touching features of the touching behavior;
generate an unlocking password according to the touching features;
match the unlocking password to a predetermined password; and
unlock a locked state when the unlocking password is matched to the predetermined password correctly.

7. The electronic device as claimed in claim 6, wherein the touching feature is touching duration, the step to generate an unlocking password according to the touching features comprises:
setting the touching duration of the touching behavior as the unlocking password;
wherein the predetermined password is generated in advance by the following methods specifically:
collecting a touching behavior acted to an electronic device by a user in accordance with a touching rule of the predetermined password; and
setting the touching duration of the touching behavior as the predetermined password and save the predetermined password, wherein the touching rule of the predetermined password comprises the touching duration corresponded with each touching behavior.

8. The electronic device as claimed in claim 6, wherein the touching feature is touching duration or a position of the touching behavior, the collecting the touching behavior acted to the electronic device by the user and obtaining the touching features of the touching behavior comprises:
collecting at least two touching behaviors acted to the electronic device by the user and obtaining the touching features of each touching behavior and duration of the interval between two consecutive touching behaviors;
the generating an unlocking password according to the touching features comprises:
generating an unlocking password according to each touching feature corresponding to each of the touching behaviors and the duration of the interval between two consecutive touching behaviors.

9. The electronic device as claimed in claim 8, wherein the generating an unlocking password according to each touching feature corresponding to each of the touch behaviors and the duration of the interval between two consecutive touching behaviors comprises:
setting each touching feature corresponding to each of the touching behaviors and the duration of the interval between the two consecutive touching behaviors as the unlocking password;
wherein the predetermined password is generated in advance by the following method specifically:
collecting at least two touching behaviors acted to the electronic device by the user in accordance with a touching rule of the predetermined password, wherein the touching rule of the predetermined password comprises each touching feature corresponding to each touching behavior and the duration of the interval between two consecutive touching behaviors; and
setting each touching feature corresponding to each of the at least two touching behaviors and the duration of the interval between the two consecutive touching behaviors as the predetermined password and save the predetermined password.

10. The electronic device as claimed in claim 8, wherein the generating an unlocking password according to each touching feature corresponding to each of the touching behaviors and the duration of the interval between two consecutive touching behaviors comprises:
converting each touching feature corresponding to each of the touching behaviors to code symbols according to different touching features corresponding to different code symbols, the duration of the interval between the code symbols, and the duration of the interval between characters, which are obtained through a permutation of the code symbols;
converting the code symbols to a combination of characters according to the duration of the interval between two consecutive touching behaviors; and
setting the combination of the characters as the unlocking password.

11. A non-transitory computer-readable storage medium storing executable instructions that, when executed by an electronic device with a touch-sensitive display, cause the electronic device to:
collect a touching behavior acted to an electronic device by a user and obtain touching features of the touching behavior;
generate an unlocking password according to the touching features;
match the unlocking password to a predetermined password; and
unlock a locked state when the unlocking password is matched to the predetermined password correctly.

12. The non-transitory computer-readable storage medium as claimed in claim 11, wherein the touching feature is touching duration, the step to generate an unlocking password according to the touching features comprises:
setting the touching duration of the touching behavior as the unlocking password;
wherein the predetermined password is generated in advance by the following methods specifically:
collecting a touching behavior acted to an electronic device by a user in accordance with a touching rule of the predetermined password; and
setting the touching duration of the touching behavior as the predetermined password and save the predetermined password, wherein the touching rule of the predetermined password comprises the touching duration corresponded with each touching behavior.

13. The non-transitory computer-readable storage medium as claimed in claim 11, wherein the touching feature is touching duration or a position of the touching behavior, the collecting the touching behavior acted to the electronic device by the user and obtaining the touching features of the touching behavior comprises:
collecting at least two touching behaviors acted to the electronic device by the user and obtaining the touching features of each touching behavior and duration of the interval between two consecutive touching behaviors;
the generating an unlocking password according to the touching features comprises:
generating an unlocking password according to each touching feature corresponding to each of the touching behaviors and the duration of the interval between two consecutive touching behaviors.

14. The non-transitory computer-readable storage medium as claimed in claim 13, wherein the generating an unlocking password according to each touching feature corresponding to each of the touch behaviors and the duration of the interval between two consecutive touching behaviors comprises:
setting each touching feature corresponding to each of the touching behaviors and the duration of the interval between the two consecutive touching behaviors as the unlocking password;
wherein the predetermined password is generated in advance by the following method specifically:
collecting at least two touching behaviors acted to the electronic device by the user in accordance with a touching rule of the predetermined password, wherein the touching rule of the predetermined password comprises each touching feature corresponding to each touching behavior and the duration of the interval between two consecutive touching behaviors; and
setting each touching feature corresponding to each of the at least two touching behaviors and the duration of the interval between the two consecutive touching behaviors as the predetermined password and save the predetermined password.

15. The non-transitory computer-readable storage medium as claimed in claim 13, wherein the generating an unlocking password according to each touching feature corresponding to each of the touching behaviors and the duration of the interval between two consecutive touching behaviors comprises
converting each touching feature corresponding to each of the touching behaviors to code symbols according to different touching features corresponding to different code symbols, the duration of the interval between the code symbols, and the duration of the interval between characters, which are obtained through a permutation of the code symbols;
converting the code symbols to a combination of characters according to the duration of the interval between two consecutive touching behaviors; and
setting the combination of the characters as the unlocking password.
